(19) United States
(12) Patent Application Publication
(10) Pub. No.: US 2005/0172004 A1
(43) Pub. Date: Aug. 4, 2005

(54) Methods and apparatuses for certifying electronic messages

(76) Inventor: Clay Fisher, San Diego, CA (US)

Correspondence Address: Valley Oak Law;#106, 5655 Silver Creek Valley Road, San Jose, CA, 95138, US

(21) Appl. No.: 10/771,746

(22) Filed: Feb. 4, 2004

(51) Int. Cl. G06F 15/16; G06F 11/30; H04L 9/32; G06F 12/14; H04L 9/00

(52) U.S. Cl. 709/206; 713/200

(57) ABSTRACT

In one embodiment, the methods and apparatuses detect an electronic message; detect an originating server associated with the electronic message; confirm with the originating server that the originating server sent the electronic message; determine a trustworthy status of the originating server; and selectively present the electronic message to a recipient device based on the trustworthy status of the originating server.

### FIELD OF THE INVENTION

The present invention relates generally to certifying electronic messages and, more particularly, to certifying electronic messages prior to transmitting the messages to a device.

### BACKGROUND

There has been a proliferation of electronic messages utilized by both business and personal users. Electronic messages are used to disseminate information in a manner similar to traditional mail.

However, unlike traditional mail, the distribution costs on a per item basis is much lower with electronic messages compared to traditional mail. Unfortunately, with the minimal distribution costs associated with distributing electronic messages, there has been an increase in “spam” (i.e. unwanted electronic messages advertising unsolicited services and/or products.) Unlike advertisements that are sent through traditional mail, the shear volume of spam can fill a user's inbox so that other valid electronic messages are discarded. Additionally, unlike advertisements that are sent through traditional mail that are simply thrown out with the garbage, spam is often time-consuming to discard.

With the pervasiveness of spam, there have been solutions to avoid spam by blocking electronic mail addresses so that future spam from this electronic mail address is prevented from sending additional spam to the user. Unfortunately, blocking individual electronic mail addresses have become ineffective, because individuals that produce spam often change their electronic mail addresses to circumvent these electronic mail address blocking systems.

### SUMMARY

In one embodiment, the methods and apparatuses detect an electronic message; detect an originating server associated with the electronic message; confirm with the originating server that the originating server sent the electronic message; determine a trustworthy status of the originating server; and selectively present the electronic message to a recipient device based on the trustworthy status of the originating server.

### BRIEF DESCRIPTION OF THE DRAWINGS

The accompanying drawings, which are incorporated in and constitute a part of this specification, illustrate and explain one embodiment of the methods and apparatuses for broadcasting information to a device. In the drawings,

FIG. 1 is a diagram illustrating an environment within which the methods and apparatuses for certifying electronic messages are implemented;

FIG. 2 is a simplified block diagram illustrating one embodiment in which the methods and apparatuses for certifying electronic messages are implemented;

FIG. 3 is a simplified block diagram illustrating a system, consistent with one embodiment of the methods and apparatuses certifying electronic messages;

FIG. 4 is an exemplary record for use with the methods and apparatuses for certifying electronic messages;

FIG. 5 is a flow diagram consistent with one embodiment of the methods and apparatuses for certifying electronic messages;

FIG. 6 is a flow diagram consistent with one embodiment of the methods and apparatuses for certifying electronic messages;

FIG. 7 is a simplified block diagram illustrating one embodiment in which the methods and apparatuses for certifying electronic messages are implemented.

### DETAILED DESCRIPTION

The following detailed description of the methods and apparatuses for certifying electronic messages refers to the accompanying drawings. The detailed description is not intended to limit the methods and apparatuses for certifying electronic messages. Instead, the scope of the methods and apparatuses for certifying electronic messages is defined by the appended claims and equivalents. Those skilled in the art will recognize that many other implementations are possible, consistent with the present invention.

References to “device” include a device utilized by a user such as a computer, a personal digital assistant, a cellular telephone, and a device capable of receiving an electronic message.

In one embodiment, the methods and apparatuses for certifying electronic messages selectively present an electronic message to a recipient based on the originating server of the electronic message. For example, if the originating server of the electronic message is deemed an untrustworthy entity, then the electronic message is not displayed to the recipient. On the other hand, if the originating server of the electronic message is deemed a trustworthy entity, then the electronic message is made available to the recipient.

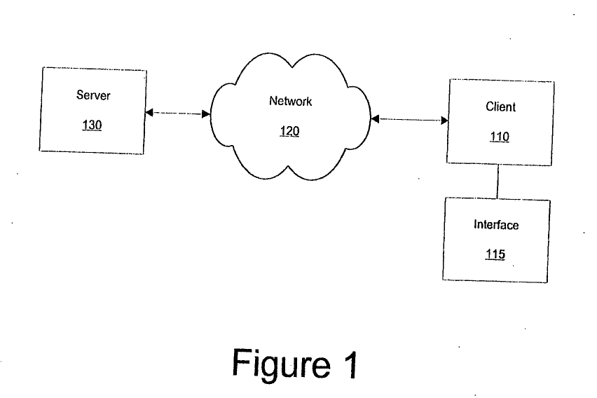

FIG. 1 is a diagram illustrating an environment within which the methods and apparatuses for certifying electronic messages are implemented. The environment includes an electronic device 110 (e.g., a computing platform configured to act as a client device, such as a computer, a personal digital assistant, a digital camera, a video camera), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., keypad and video display screen input and output interfaces in the same housing as personal digital assistant electronics (e.g., as in a Clie® manufactured by Sony Corporation). In other embodiments, one or more user interface 115 components (e.g., a keyboard, a pointing device (mouse, trackball, etc.), a microphone, a speaker, a display, a camera are physically separate from, and are conventionally coupled to, electronic device 110. The user utilizes interface 115 to access and control content and applications stored in electronic device 110, server 130, or a remote storage device (not shown) coupled via network 120.

In accordance with the invention, embodiments of certifying electronic messages below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

The methods and apparatuses for certifying electronic messages are shown in the context of exemplary embodiments of applications in which the origins of the electronic messages are authenticated prior to making the electronic messages available to the recipient. In one embodiment, prior to broadcasting the electronic message to a device operated by the recipient, the originating server of the electronic message is pre-approved as a trustworthy server. In another embodiment, the originating server of the electronic message is selected within the recipient's profile prior to broadcasting the electronic message to a device operated by the recipient. In yet another embodiment, prior to displaying the electronic message to the recipient, the originating server of the electronic message is considered a trustworthy server. In one embodiment, the electronic message is selectively transmitted to the electronic device 110 that is operated by the recipient through the network 120.

In one embodiment, the methods and apparatuses for certifying electronic messages utilize a record associated with an identity of a mail server that corresponds to the origins of an electronic message. In one embodiment, the record includes details relating to the originating server such as whether the originating server is trustworthy, and whether the originating server is an accepted mail server on the recipient's profile.

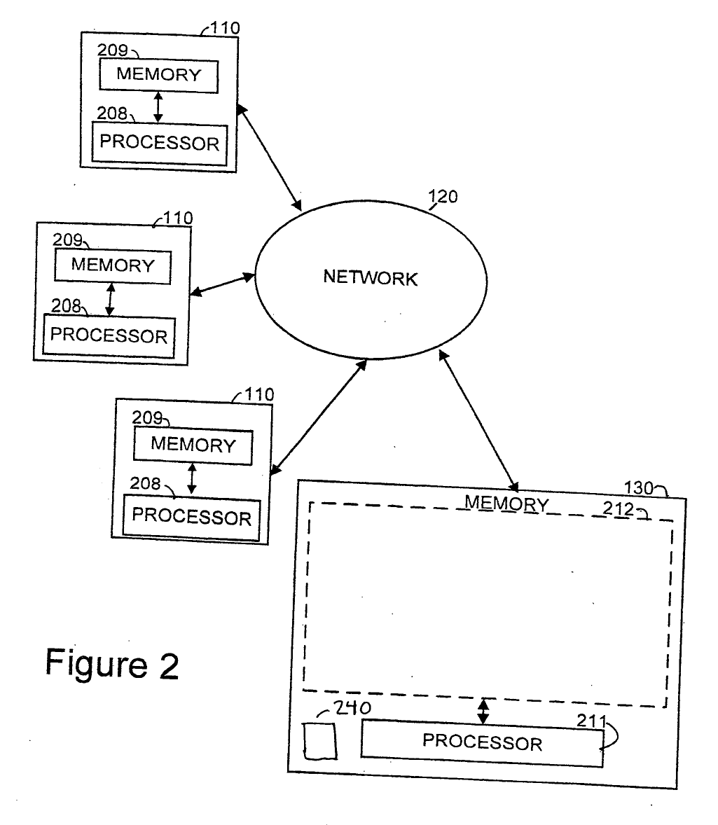

FIG. 2 is a simplified diagram illustrating an exemplary architecture in which the methods and apparatuses for certifying electronic messages are implemented. The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. A unique user operates each electronic device 110 via an interface 115 as described with reference to FIG. 1.

Server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

The plurality of client devices 110 and the server 130 include instructions for a customized application broadcasting electronic messages to a device. In one embodiment, the plurality of computer-readable media 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in media 209, in media 212, or a single user application is stored in part in one media 209 and in part in media 212. In one instance, a stored user application, regardless of storage location, is made customizable based on certifying electronic messages as determined using embodiments described below.

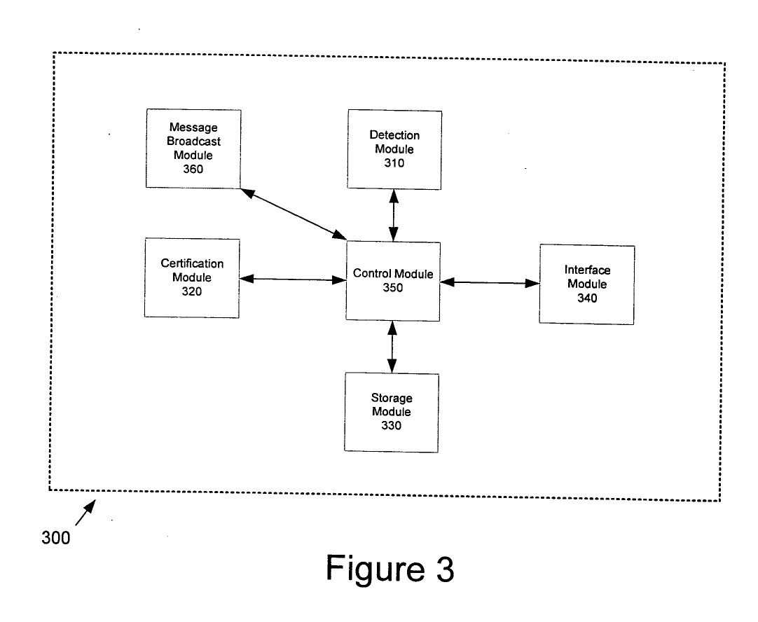

FIG. 3 illustrates one embodiment of a system 300. In one embodiment, the system 300 is embodied within the server 130. In another embodiment, the system 300 is embodied within the electronic device 110. In yet another embodiment, the system 300 is embodied within both the electronic device 110 and the server 130.

In one embodiment, the system 300 includes a detection module 310, a certification module 320, a storage module 330, an interface module 340, a control module 350, and a message broadcast module 360.

In one embodiment, the control module 350 communicates with the detection module 310, the certification module 320, the storage module 330, the interface module 340, and the message broadcast module 360. In one embodiment, the control module 350 coordinates tasks, requests, and communications between the detection module 310, the certification module 320, the storage module 330, the interface module 340, and the message broadcast module 360.

In one embodiment, the detection module 310 detects the identity of the originating server that is the origin of the electronic message. For example, each electronic message originates from an originating mail server that is associated with the sender of the electronic message. In one embodiment, the detection module 310 determines the identity of the originating server through a digital certificate that is transmitted with the electronic message. In this example, the digital certificate uniquely identifies the originating server.

In one embodiment, the electronic message passes through multiple servers after leaving the originating mail server and prior to being received by a target mail server that is associated with the recipient of the message. In this example, the detection module 310 is capable of detecting the identity of the originating mail server regardless of the intervening servers subsequent to leaving the originating mail server.

In another embodiment, the detection module 310 confirms that the originating server sent the electronic message. In one embodiment, the detection module 310 transmits a signal to the originating server to confirm that the originating server sent the electronic message. In one embodiment, this confirmation by the detection module 310 does not require further interaction from the sender or the recipient of the electronic message. In this embodiment, the detection module 310 provides a server to server confirmation between the system 300 and the originating server that prevents another server from falsely utilizing the identity of the originating server for sending the electronic message. For example, when a third party creates an electronic message that falsifies the originating server, the server to server confirmation performed by the detection module 310 warns that the originating server did not create the electronic message.

In one embodiment, the certification module 320 determines whether the originating server is considered trustworthy by the system 300. There are multiple factors that are utilized to determine whether an originating server should be considered trustworthy. In one embodiment, the number of complaints of spammers or incidents of spam is one factor. In another embodiment, the policies and practices that the mail server implements to curb spam and spammers is another factor. In yet another embodiment, feedback from the recipient of the electronic message on whether the originating server is a trustworthy entity is yet another factor.

In one embodiment, the certification module 320 analyzes unknown mail servers that have not been previously authorized as trustworthy by the certification module 320. In another embodiment, certification module 320 performs an update on mail servers that have been previously authorized as trustworthy by the certification module 320. In yet another embodiment, the certification module 320 receives input from the user on whether the unknown server should be considered a trustworthy entity.

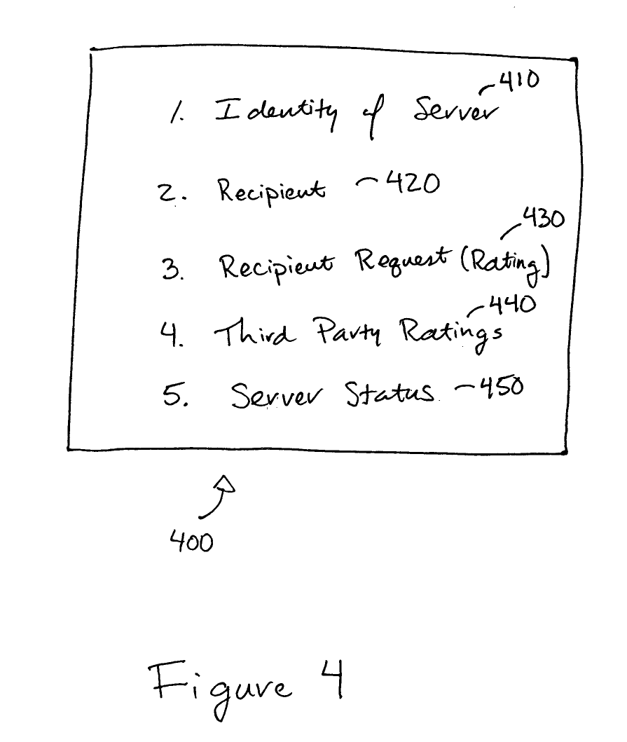

In one embodiment, the storage module 330 stores a record including information associated with a mail server that is authorized as a trustworthy entity. In another embodiment, the storage module 330 stores a unique identifier that represents a particular email server. An exemplary embodiment of the information contained within the record is illustrated in FIG. 4.

In one embodiment, the interface module 340 receives a signal indicating that an electronic message has been received for the recipient. In another embodiment, the interface module 340 receives a signal from one of the electronic devices 110. For example, in one instance, the electronic device transmits a signal authorizing a server as a trustworthy entity. In yet another embodiment, the interface module 340 displays information contained within the record associated with the particular server that is identified in an electronic message received by one of the devices 110.

In one embodiment, the message broadcast module 360 prepares the electronic message to be broadcasted to the device associated with the recipient of the electronic message. In another embodiment, the broadcast module 360 prepares the electronic message to be broadcasted based on the particular server that originated the electronic message and whether the particular server is considered a trustworthy entity.

The system 300 in FIG. 3 is shown for exemplary purposes and is merely one embodiment of the methods and apparatuses for certifying electronic messages. Additional modules may be added to the system 300 without departing from the scope of the methods and apparatuses for certifying electronic messages. Similarly, modules may be combined or deleted without departing from the scope of the methods and apparatuses for certifying electronic messages.

FIG. 4 illustrates an exemplary record 400 for use with the system 300. In one embodiment, each record 400 is associated with an originating server corresponding with an electronic message. In one embodiment, the record 400 includes an identity of the server field 410, a recipient field 420, a recipient request field 430, a third party ratings field 440, and a server status field 450.

In one embodiment, the identity of the server field 410 uniquely identifies the server. In one example, a unique identification number is transmitted with the electronic message to identify the originating server of the electronic message. In another example, the originating server is authenticated with a digital certificate and embeds the electronic messages with this unique digital certificate.

In one embodiment, the recipient field 420 identifies a recipient of an electronic message associated with the originating server as identified in the identity of the server field 410.

In use, the identity of the server field 410 and the recipient field 420 determine whether the particular record 400 is applicable for a given electronic message. For example, if the originating server associated with a particular electronic message does not match the identity of the server field 410 of a record 400, then this record 400 is not applicable to the particular electronic message. Similarly, if the recipient of a particular electronic message does not match the recipient field 420 of a record 400, then this record 400 is not applicable to the particular electronic message.

In one embodiment, the recipient request field 430 allows the recipient to rate the originating server as being a trustworthy entity or an untrustworthy entity. If the originating server is rated as a trustworthy entity, electronic messages originating from this server will more likely be certified by the system and broadcasted to the recipient. However, if the originating server is rated as an untrustworthy entity, electronic messages originating from this server will less likely be certified by the system and broadcasted to the recipient.

In one embodiment, the third party ratings field 440 allows other sources to rate whether the originating server should be considered a trustworthy or untrustworthy entity. For example, information rating services or websites track spam policies of the originating server, amount of spam generated by the originating server, and the like. In another embodiment, internal resources within the system 300 also track whether the originating server should be considered a trustworthy or untrustworthy entity.

In one embodiment, the server status field 450 indicates whether the originating server is considered a trustworthy or untrustworthy entity. In one embodiment, the system 300 utilizes the contents of the recipient request field 430 and the third party ratings field 440 to determine whether the originating server should be considered a trustworthy or untrustworthy entity. In one embodiment, the server status field 450 is updated on a periodic schedule based, in part, on the contents of the recipient request field 430 and the third party ratings field 440.

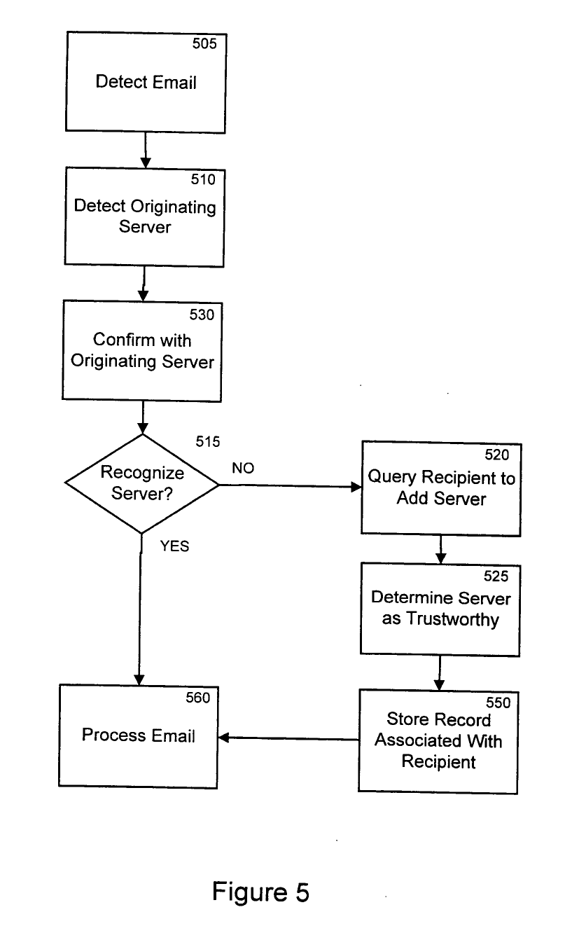

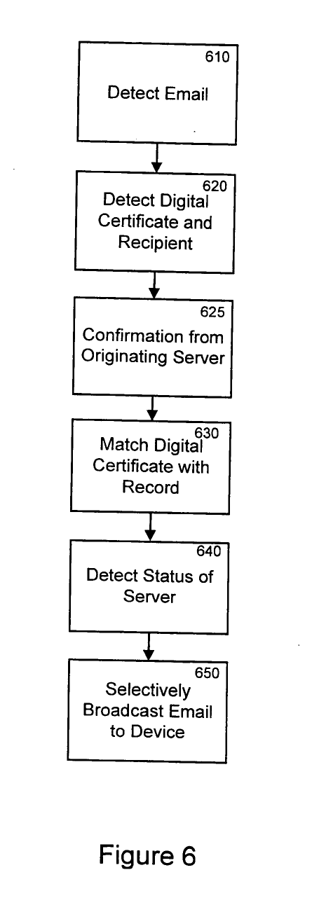

The flow diagrams as depicted in FIGS. 5 and 6 are one embodiment of the methods and apparatuses for certifying electronic messages. The blocks within the flow diagrams can be performed in a different sequence without departing from the spirit of the methods and apparatuses for certifying electronic messages. Further, blocks can be deleted, added, or combined without departing from the spirit of the methods and apparatuses for certifying electronic messages.

The flow diagram in FIG. 5 illustrates adding a server associated with a recipient's profile according to one embodiment of the invention. In Block 505, an electronic message addressed to a recipient is detected.

In Block 510, a server that originated the electronic message is detected. Each electronic message is associated with an originating server. In one embodiment, the originating server of the electronic message is detected through the detection module 310.

In one embodiment, the originating server is detected through the routing information attached to the electronic message. In another embodiment, the originating server is detected through a digital certificate attached to the electronic message that is associated with the originating server. In one embodiment, the recipient is also detected.

In Block 530, a confirmation is supplied that the originating server initiated the electronic message. In one embodiment, the detection module 310 transmits a signal to the originating server to confirm that the originating server sent the electronic message. In one embodiment, this confirmation by the detection module 310 does not require further interaction from the sender or the recipient of the electronic message. In this embodiment, the detection module 310 provides a server to server check that prevents another server from falsely utilizing the identity of the originating server for sending the electronic message.

In Block 515, the originating server is searched within the profile for the recipient. If the originating server is not found, the recipient is asked to add this originating server to the recipient's profile in the Block 520.

In Block 525, the originating server is determined to be a trustworthy or untrustworthy entity. Many factors are utilized to determine whether an originating server is trustworthy or not. For example, statistics of the number of spam electronic messages originating from the server, policies of the server for controlling spam, and the recipient's experience with receiving spam from the server are a few exemplary factors that contribute to finding a particular server as a trustworthy or untrustworthy entity.

In one embodiment, the determination of the server's trustworthiness is rated by the recipient request field 430 and the third party ratings field 440 within the record 400.

In Block 540, a record containing the digital certificate identifying the server and the status of the is stored.

In Block 550, a record containing information identifying the originating server and the status of the server as a trustworthy or untrustworthy entity is stored in association with the recipient's profile.

In Block 560, the electronic message is processed according the record associated with the originating server and the recipient of the electronic message.

The flow diagram in FIG. 6 illustrates selectively broadcasting the electronic message to the recipient according to one embodiment of the invention. In Block 610, an electronic message addressed to a recipient is detected.

In Block 620, a server that originated the electronic message is detected. Each electronic message is associated with an originating server. In one embodiment, the originating server of the electronic message is detected through the detection module 310.

In one embodiment, the originating server is detected through the routing information attached to the electronic message. In another embodiment, the originating server is detected through a digital certificate attached to the electronic message that is associated with the originating server. In one embodiment, the recipient is also detected.

In Block 625, a confirmation is supplied that the originating server initiated the electronic message. In one embodiment, the detection module 310 transmits a signal to the originating server to confirm that the originating server sent the electronic message. In one embodiment, this confirmation by the detection module 310 does not require further interaction from the sender or the recipient of the electronic message. In this embodiment, the detection module 310 provides a server to server check that prevents another server from falsely utilizing the identity of the originating server for sending the electronic message.

In Block 630, the digital certificate from the electronic message and the recipient of the electronic message is matched to a record corresponding to the originating server and the recipient.

In Block 640, the status of the originating server is detected. For example, the server is rated based on whether the server is considered a trustworthy or untrustworthy entity for receiving electronic messages.

In Block 650, the electronic message is selectively transmitted to the recipient based on the status of the originating server. For example, if the originating server is deemed trustworthy, then the electronic message originating from this server is transmitted to the recipient. However, if the originating server is deemed untrustworthy, then the electronic message originating from this server is withheld and not transmitted to the recipient.

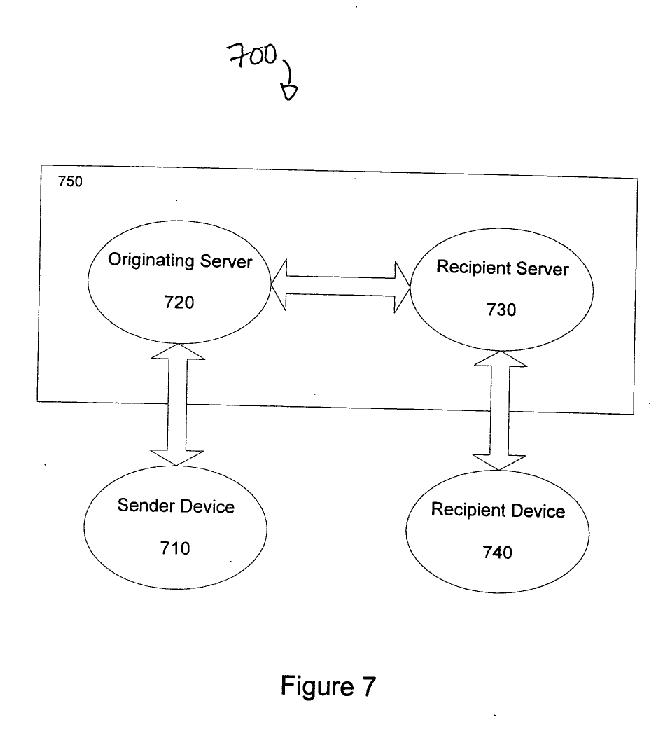

FIG. 7 illustrates an exemplary system 700 for transmitting an electronic message from a sender device 710 addressed to a recipient device 740. In one embodiment, a sender operates the sender device 710, and a recipient operates the recipient device 740. In one embodiment, the sender device 710 and the recipient device 740 is a device such as a computer, a cellular phone, a pager, a personal digital assistant, and the like.

In one embodiment, a network 750 links the sender device to an originating server 720, links the originating server 720 to a recipient server 730, and links the recipient server 730 to the recipient device 740. In one embodiment, the network 750 is the Internet. In another embodiment, portions of the network 750 are a private network including transmission by direct cabling systems, microwave systems, cellular systems, satellite systems, and the like.

In use, the sender device 710 transmits an electronic message to the originating server 720 that is addressed to the recipient device 740. In one embodiment, the originating server 720 processes the electronic message and attaches a unique identifier to the electronic message such that the originating server 720 is associated with the electronic message. For example, in one embodiment, a digital certificate is utilized for identifying the originating server 720.

In one embodiment, the originating server 720 routes the electronic message to the recipient server 730. In one embodiment, the electronic message is routed through multiple entities prior to being received by the recipient server 730. In another embodiment, the electronic message is routed directly from the originating server 720 to the recipient server 730.

In one embodiment, the system 300 is located within the recipient server 730. In another embodiment, the system 300 is located within both the recipient server 730 and the recipient device 740. In yet another embodiment, the system 300 is located within the recipient device 740.

Regardless of the location, the system 300 processes the electronic message addressed to the recipient device 740 such that the electronic message is available to the recipient if the originating server 720 is considered trustworthy. In one embodiment, the electronic message is selectively delivered from the recipient server 730 to the recipient device 740 based on whether the originating server 730 is trustworthy. If the originating server 730 is considered untrustworthy, then the electronic message is not delivered to the recipient device 740.

In another embodiment, the electronic message is delivered to the recipient device 740 regardless of the trustworthiness of the originating server 720. In this embodiment, the recipient device 740 prevents the recipient from accessing the electronic message if the originating server 720 is considered untrustworthy.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method comprising:
detecting an electronic message;
detecting an originating server associated with the electronic message;
confirming with the originating server that the originating server sent the electronic message;
determining a trustworthy status of the originating server; and
selectively presenting the electronic message to a recipient device based on the trustworthy status of the originating server.

2. The method according to claim 1 wherein the electronic message includes text.

3. The method according to claim 1 wherein the electronic message includes graphics.

4. The method according to claim 1 wherein the electronic message includes an identifier that uniquely identifies the originating server.

5. The method according to claim 1 wherein the electronic message includes a digital certificate that uniquely identifies the originating server.

6. The method according to claim 1 further comprising updating the trustworthy status of the originating server based on third party ratings of the originating server.

7. The method according to claim 1 further comprising updating the trustworthy status of the originating server based on feedback from the recipient device.

8. The method according to claim 1 wherein selectively presenting further comprises selectively displaying the electronic message on the recipient device based on the trustworthy status of the originating server.

9. The method according to claim 1 further comprising assigning a digital certificate to the originating device.

10. The method according to claim 1 further comprising storing the trustworthy status within a storage device.

11. The method according to claim 1 further comprising searching for the trustworthy status of the originating server.

12. The method according to claim 1 wherein the recipient device is a computer.

13. The method according to claim 1 wherein the recipient device is a cellular phone.

14. The method according to claim 1 wherein the recipient device is a personal digital assistant.

15. The method according to claim 1 wherein selectively presenting further comprises selectively transmitting the electronic message on the recipient device based on the trustworthy status of the originating server.

16. A system comprising:
means for detecting an electronic message;
means for detecting an originating server associated with the electronic message;
means for confirming with the originating server that the originating server sent the electronic message;
means for determining a trustworthy status of the originating server; and
means for selectively presenting the electronic message to a recipient based on the trustworthy status of the originating server.

17. A method comprising:
detecting an electronic message;
detecting an originating server associated with the electronic message;
confirming with the originating server that the originating server sent the electronic message;
matching an identity of the originating server with a record that contains information regarding the originating server; and
selectively delivering the electronic message to a recipient based on information contained within the record.

18. The method according to claim 17 wherein matching further comprises matching the recipient of the electronic message with a recipient identity of the record.

19. The method according to claim 17 wherein the information within the record includes a trustworthy status of the originating server.

20. The method according to claim 17 wherein the information within the record includes a third party rating of the originating server.

21. The method according to claim 17 wherein the information within the record includes a recipient request of the originating server.

22. The method according to claim 17 further comprising forming a new record including an identity information of the originating server and the recipient.

23. The method according to claim 22 wherein the new record further includes the trustworthy status of the originating server.

24. The method according to claim 17 further comprising selectively delivering the electronic message to a device operated by the recipient based on the trustworthy status.

25. The method according to claim 17 further comprising selectively displaying the electronic message on a device operated by the recipient based on the trustworthy status.

26. A system, comprising:
a detection module to detect an originating server associated with an electronic message;
a storage module to store a record containing information associated with the originating server; and
a broadcast module to selectively display the electronic message to a recipient based on the information within the record.

27. The system according to claim 26 wherein the information includes a trustworthy status of the originating server.

28. The system according to claim 26 wherein the broadcast module further selectively transmits the electronic message to a device operated by the recipient.

29. The system according to claim 26 further comprising an interface module for transmitting the information to the device.

30. A computer-readable medium having computer executable instructions for performing a method comprising:
detecting an electronic message;
detecting an originating server associated with the electronic message; and
matching an identity of the originating server with a record that contains information regarding the originating server;
selectively delivering the electronic message to a recipient based on information contained within the record.
